(19) United States
(12) Patent Application Publication
(10) Pub. No.: US 2026/0244378 A1
(43) Pub. Date: Aug. 20, 2026

(54) PRINT DATA INTERCEPTION AND PROCESSING SYSTEM

(71) Applicant: Neal J. Lober, McKinney, TX (US)

(72) Inventor: Neal J. Lober, Dallas, TX (US)

(21) Appl. No.: 19/057,817

(22) Filed: Feb. 19, 2025

(51) Int. Cl. G06F 3/12; G06K 1/12

(52) U.S. Cl. CPC G06F 3/1243; G06F 3/1204; G06K 1/121; G06F 3/1275; G06F 3/1285

(57) ABSTRACT

Approaches are described for intercepting, processing, and formatting output data fields for labeling workflows, including RFID encoding and compliance with industry standards. A print data interception and processing system (PDIPS) is operable to intercept formatted output data, such as print job data, from user devices. The system identifies relevant output data fields, applies mapping rules to associate fields with label formats, encodes RFID tags with serialization data, and formats the label content according to regulatory or enterprise standards. The processed data is transmitted to label output devices, enabling the creation of physical labels, electronic displays, or other outputs. The PDIPS may utilize machine learning models to facilitate automatic field mapping and dynamic template generation. The system can be implemented across various configurations, including standalone devices, firmware-based systems, software deployments, and cloud-based architectures.

### BACKGROUND

### Field of the Art

The systems and methods disclosed herein are related generally to data processing systems and, more specifically, to systems and methods for managing, processing, and encoding output data fields, including label data, for compliance with industry standards and efficient deployment.

### Discussion of the State of the Art

Manufacturers face challenges in meeting RFID labeling requirements imposed by retailers and industry standards. Current workflows often require manual integration with enterprise resource planning (ERP) systems, the use of separate RFID encoding devices, and modifications to existing label printing systems. This manual process can be time-consuming, error-prone, and disruptive to existing workflows.

Existing solutions typically involve adding standalone RFID printers or encoders to the network, which require reconfiguration of label printing software and additional manual steps to integrate encoded RFID data with printed labels. These solutions often fail to seamlessly integrate with manufacturers'existing infrastructure and workflows.

Another challenge is the lack of flexible systems that can process label data automatically, apply mapping rules, and ensure compliance with standards such as GS1. Conventional approaches frequently involve static templates or rigid systems that cannot adapt to changing requirements or varied label formats.

Some systems attempt to offload tasks like RFID encoding or label formatting to cloud-based services. While these systems provide scalability, they often lack hybrid deployment options that can combine the benefits of local processing and cloud resources. This limitation can result in latency issues or dependence on continuous internet connectivity, which may not be suitable for all manufacturing environments.

Thus, there remains a need for a system that can integrate with existing workflows, handle both local and cloud-based deployments, and automate the processes of RFID encoding, label mapping, and formatting while maintaining compliance with evolving industry standards.

### SUMMARY

Systems and methods in accordance with the embodiments described herein address the technical challenges associated with integrating RFID encoding, output data field mapping, and formatting into existing workflows. In particular, the disclosed systems provide a Print Data Interception and Processing System (PDIPS) operable to intercept formatted output data, such as print data, map output data fields, encode RFID tags, and format the data according to industry standards, such as GS1.

As used herein, “formatted output data” refers to data that is intercepted, processed, and prepared for output in various forms, including printed labels, electronic displays, or encoded RFID tags. “Print data” represents a specific type of formatted output data used for physical label generation via printers. Similarly, “label data” refers to a particular instance of output data fields used in labeling workflows, encompassing barcodes, text, graphical elements, and RFID tags.

In an embodiment, the PDIPS operates as a virtual printer deployed as a standalone network-connected device, integrated within printer firmware, or implemented as software on a computing device. The system intercepts formatted output data, including print job data from user devices, and processes the data to ensure proper mapping of output data fields, RFID tag serialization, and formatting in accordance with required label standards. The processed formatted output data can then be transmitted to output devices, such as label printers, for printing or other forms of output.

In certain embodiments, the PDIPS utilizes a hybrid deployment model where local processing capabilities are combined with cloud-based resources. This configuration enables the system to distribute resource-intensive tasks, such as machine learning-based label mapping, between on-premises hardware and cloud servers. The hybrid architecture provides flexibility for manufacturers with varying infrastructure requirements.

In an embodiment, the system includes a mapping module operable to associate data fields of formatted output data with predefined formats, either manually or using machine learning models. The mapping module may interact with a label layout database, a standards database, or other appropriate databases to ensure that label designs adhere to compliance requirements and accommodate customization needs.

In an embodiment, the PDIPS includes an RFID encoding engine operable to retrieve serialization data from an RFID tag serialization database or other appropriate database, encode this data onto RFID tags, and verify the encoding. This process integrates RFID functionality directly into the label processing workflow, removing the need for separate encoding hardware or manual encoding steps.

In accordance with various embodiments, the disclosed system includes multiple components, such as user device interfaces, label output device interfaces, enterprise system interfaces, and databases to manage RFID serialization, label layouts, and configuration policies. These components enable the system to integrate with existing manufacturing and supply chain environments while automating compliance with industry labeling standards.

Advantageously, the disclosed system improves the field of formatted output data processing and label encoding by addressing challenges associated with automating data mapping, encoding, and formatting tasks. The system is operable to transform formatted output data into standardized formats, encode RFID tags efficiently, and ensure compliance with industry-specific requirements. These improvements enhance the technical field by enabling streamlined and efficient data processing for manufacturing and labeling operations.

Various other functions and embodiments are described and suggested below as may be provided in accordance with the various embodiments.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates the network architecture of a print data interception and processing system (PDIPS) in accordance with various embodiments.

FIG. 2 illustrates an example computing environment including a print data interception and processing system in accordance with an exemplary embodiment.

FIG. 3A illustrates an example standalone deployment of print data interception and processing system (PDIPS) that can be utilized in accordance with various embodiments.

FIG. 3B illustrates an example embedded deployment of print data interception and processing system (PDIPS) that can be utilized in accordance with various embodiments.

FIG. 3C illustrates an example software deployment of print data interception and processing system (PDIPS) that can be utilized in accordance with various embodiments.

FIG. 3D illustrates an example cloud-based deployment of print data interception and processing system (PDIPS) that can be utilized in accordance with various embodiments.

FIG. 4 illustrates an example process for intercepting, processing, and outputting output data fields that can be utilized in accordance with various embodiments.

FIG. 5 illustrates an example subprocess for mapping output data fields to formatting rules in accordance with various embodiments.

FIG. 6 illustrates an example subprocess for encoding RFID tags as part of a label processing workflow in accordance with various embodiments.

FIG. 7 illustrates an example subprocess for formatting output data fields in accordance with various embodiments.

FIG. 8 illustrates one embodiment of the computing architecture that supports an embodiment of the inventive disclosure.

FIG. 9 illustrates components of a system architecture that supports an embodiment of the inventive disclosure.

FIG. 10 illustrates components of a computing device that supports an embodiment of the inventive disclosure.

FIG. 11 illustrates components of a computing device that supports an embodiment of the inventive disclosure.

### DETAILED DESCRIPTION

The embodiments described herein relate to systems and methods for intercepting, processing, and outputting output data fields with integrated RFID encoding and compliance functionality. The system is operable to intercept print job data, apply mapping and formatting rules, and encode RFID tags using data retrieved from appropriate databases, such as serialization databases. In various embodiments, the system may operate as a standalone network-connected device, as software integrated into printer firmware, or in a hybrid cloud-based deployment. The system is further operable to automate label formatting and ensure compliance with industry standards, such as GS1, while accommodating customizable workflows. In certain embodiments, the system can process data locally or leverage cloud resources for machine learning-based mapping and other resource-intensive tasks, enabling flexible deployment options tailored to manufacturing and labeling environments.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Conceptual Architecture

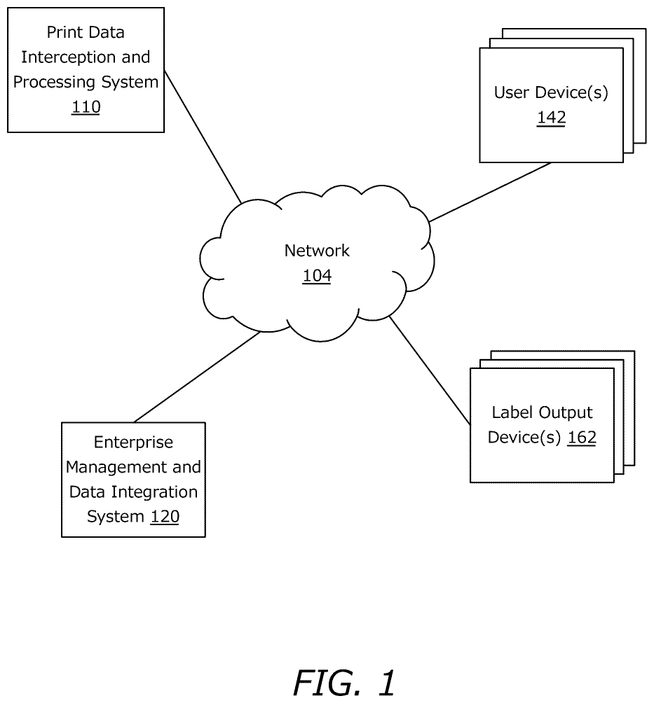

FIG. 1 illustrates the network architecture of a print data interception and processing system (PDIPS) in accordance with various embodiments. It should be understood that reference numbers are carried over between figures for similar components for purposes of simplicity of explanation, but such usage should not be construed as a limitation on the various embodiments unless otherwise stated. In an embodiment, the system may be comprised of a print data interception and processing system 110, user device(s) 142, label output device(s) 162, an enterprise management and data integration system 120, and a network 104, over which the various systems and devices communicate and interact.

The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Print data interception and processing system (PDIPS) 110 is operable to intercept print job data transmitted from user device(s) 142 and process the data to enable RFID encoding and label formatting. In an embodiment, PDIPS 110 is configured to identify and extract relevant output data fields from the intercepted print job, applying mapping and formatting rules to standardize the output data for compliance with industry standards, such as GS1. PDIPS 110 is further operable to encode RFID tags with serialization data retrieved from an RFID tag serialization database or other appropriate databases. For example, label data—a specific instance of output data fields tailored to labeling workflows—may include barcodes, product identifiers, shipping addresses, or graphical logos embedded within the broader formatted output data.

PDIPS 110 may be deployed in various configurations, including as a standalone network-connected device, software integrated into printer firmware, or as part of a hybrid deployment leveraging local and cloud-based processing. For example, in one embodiment, PDIPS 110 operates as a virtual printer, appearing to user device(s) 142 as a standard network printer while performing advanced data processing tasks, such as encoding RFID data and formatting labels in real-time.

In certain embodiments, PDIPS 110 incorporates a mapping module operable to associate label fields with corresponding data elements, such as UPC codes, product descriptions, or SKU identifiers. This module may use predefined mapping rules stored in a configuration and policy database or dynamically generate mappings through a machine learning-based analysis of the label layout.

PDIPS 110 is further operable to output formatted output data fields, including label data, to label output device(s) 162 in a printer-specific language, such as ZPL or EPL. In an embodiment, PDIPS 110 may also perform error checking and validation to ensure that the formatted label data meets the requirements for both printing and RFID encoding.

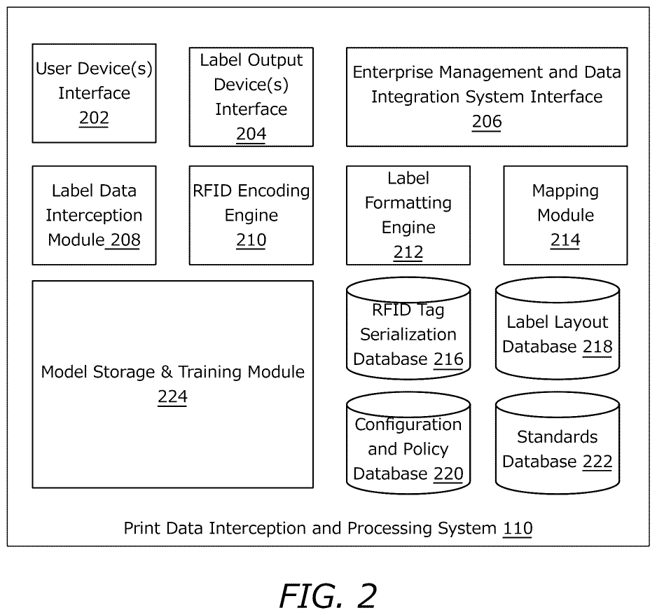

As will be described further in FIG. 2, PDIPS 110 includes multiple components, such as interfaces to user device(s) 142 and label output device(s) 162, an RFID encoding engine, and a label formatting engine. These components work in coordination to automate label processing and encoding tasks, enabling manufacturers to comply with labeling standards efficiently.

User device(s) 142 can include, generally, any computing device that is operable to communicate over a network 104. Data may be transmitted from user device(s) 142, including print job data intended for processing by print data interception and processing system (PDIPS) 110. User device(s) 142 may include a server, a desktop computer, a laptop computer, a tablet, a smartphone, or any other suitable computing device. User device(s) 142 may execute one or more applications, such as label design software, a dedicated PDIPS interface, or a web-based platform, that facilitates the preparation and transmission of print jobs for processing.

In an embodiment, user device(s) 142 are operable to communicate with PDIPS 110 via a virtual printer interface or other appropriate protocols. For example, user device(s) 142 may generate print jobs containing output data fields, including label data, formatted in standard or custom templates, which PDIPS 110 intercepts for further processing. These devices may also provide manual input for label mapping tasks, such as selecting and associating label fields, or managing mapping rules through a graphical user interface.

In various embodiments, user device(s) 142 can include applications capable of previewing processed label layouts, monitoring the status of print jobs, or managing access to configuration settings within the PDIPS 110. For instance, an application may allow users to visualize the mapping of data fields to label elements before the label is transmitted to label output device(s) 162.

User device(s) 142 may include web browsers, such as MICROSOFT EDGE, GOOGLE CHROME, or APPLE SAFARI, enabling users to access PDIPS 110 via a network connection. These browsers may support interactions with a web-based PDIPS interface, where users can upload print jobs, manage configurations, or review processing logs. In certain embodiments, user device(s) 142 may also host locally installed software applications dedicated to interacting with PDIPS 110 for enhanced functionality.

Exemplary user devices include desktop computers, laptops, tablets, smartphones, and other mobile devices operable to perform the functions described herein. The present disclosure contemplates any suitable user device(s) that are capable of communicating with network 104 and interacting with the PDIPS 110 in real time, through cloud-based or locally installed applications. Where appropriate, user device(s) 142 may also provide feedback to PDIPS 110 or access print job processing reports to support administrative tasks and troubleshooting.

Label output device(s) 162 can include, generally, any device operable to receive processed print job data from the print data interception and processing system (PDIPS) 110 and output corresponding physical labels. In various embodiments, label output device(s) 162 may include printers configured to handle standard label formats, RFID-enabled label printers, or multi-function printing devices capable of producing various types of labels. These devices may support communication over network 104, allowing them to interface with PDIPS 110 for receiving processed output data fields, including label data, and printing instructions.

In an embodiment, label output device(s) 162 are operable to print labels with embedded RFID tags encoded by PDIPS 110. For example, the device may include hardware components, such as RFID encoders and antennas, that embed serialization data into RFID tags during the label printing process. In this configuration, label output device(s) 162 may operate using printer-specific languages, such as ZPL or EPL, to execute the printing and encoding instructions provided by PDIPS 110.

Label output device(s) 162 can also support various label media types, including adhesive labels, hang tags, and other forms of product labeling materials. For instance, in one embodiment, a label output device 162 may be configured to handle high-volume printing of compliance labels for supply chain and inventory management purposes. Additionally, label output device(s) 162 may include functionality for error reporting, allowing them to send feedback to PDIPS 110 in cases where a label fails to print or encode correctly.

In certain embodiments, label output device(s) 162 may include integrated processing capabilities to manage portions of the print job, such as adjusting label layout parameters or performing pre-flight checks on received data. These devices may also store localized configuration data for quick access to commonly used label formats or RFID encoding profiles.

Exemplary label output devices include industrial-grade RFID printers, desktop label printers, and specialized printing systems used in manufacturing and logistics environments. The present disclosure contemplates any suitable label output device(s) capable of communicating with PDIPS 110 and producing compliant labels for a variety of applications.

Enterprise management and data integration system 120 is operable to manage and synchronize data across various components of the network architecture, ensuring communication between the print data interception and processing system (PDIPS) 110 and other enterprise-level systems. In various embodiments, enterprise management and data integration system 120 integrates with enterprise resource planning (ERP) systems, warehouse management systems (WMS), and other business-critical software platforms to provide access to data necessary for label generation, RFID serialization, and compliance reporting.

In an embodiment, enterprise management and data integration system 120 facilitates the exchange of data between PDIPS 110 and backend systems, such as inventory databases and regulatory compliance databases. For example, enterprise management and data integration system 120 may provide product details, stock-keeping unit (SKU) identifiers, and shipment information required to populate label fields. Additionally, the system is operable to retrieve serialization data for RFID encoding, ensuring compliance with industry standards, such as GS1.

Enterprise management and data integration system 120 may include interfaces for data extraction, transformation, and loading (ETL) to standardize and prepare data for use by PDIPS 110. For instance, the system may format raw data from ERP systems into predefined templates compatible with label mapping and formatting rules within PDIPS 110. The system may also enforce access policies and user permissions to ensure that only authorized entities can modify or retrieve critical data.

In certain embodiments, enterprise management and data integration system 120 supports real-time data synchronization, enabling dynamic updates to label information and serialization data as changes occur in the source systems. For example, when inventory levels or product specifications are updated within an ERP system, enterprise management and data integration system 120 can propagate these changes to PDIPS 110 to ensure that labels reflect the most current data.

Exemplary configurations of enterprise management and data integration system 120 may include cloud-based platforms, on-premises servers, or hybrid deployments. The system may utilize APIs, middleware solutions, or direct database connections to facilitate data exchange. In one embodiment, the system includes error-checking and logging functionalities to monitor data exchanges and ensure the accuracy of transmitted information.

Network 104 generally represents a network or collection of networks (such as the Internet, a corporate intranet, or a combination thereof) over which the various components illustrated in FIG. 1, including print data interception and processing system 110, user device(s) 142, label output device(s) 162, and enterprise management and data integration system 120, communicate and interact. In particular embodiments, network 104 is an intranet, an extranet, a virtual private network (VPN), a local area network (LAN), a wireless LAN (WLAN), a wide area network (WAN), a metropolitan area network (MAN), a portion of the Internet, or another network 104, or a combination of two or more such networks. One or more links connect the systems and databases described herein to network 104. In particular embodiments, one or more links each include one or more wired, wireless, or optical links. The present disclosure contemplates any suitable network, and any suitable link for connecting the various systems and databases described herein.

Network 104 connects the various systems and devices, enabling the flow of print job data, label mapping instructions, and encoded RFID data between components. For example, network 104 facilitates the transmission of formatted output data, such as print data, intercepted by print data interception and processing system 110 from user device(s) 142 to label output device(s) 162, as well as interactions with enterprise management and data integration system 120 for retrieving and updating relevant data.

One or more links couple one or more systems, engines, or devices to network 104. In particular embodiments, one or more links each includes one or more wired, wireless, or optical links. These links enable high-speed and secure data transmission between local and remote deployments of the system, supporting various configurations, such as on-premise, cloud-based, or hybrid implementations.

In particular embodiments, each system or engine may be a unitary server or a distributed server spanning multiple computers or datacenters. For example, a cloud-based deployment of print data interception and processing system 110 may utilize network 104 to offload resource-intensive tasks, such as machine learning-based mapping or large-scale RFID encoding, while synchronizing with local systems for real-time operations.

In certain embodiments, network 104 facilitates interactions with multiple databases, including an RFID tag serialization database, a label layout database, and a standards database, which are used by the various system components. These databases may be hosted locally or in a cloud environment, depending on the specific deployment configuration.

The system may also contain other subsystems and databases, not illustrated in FIG. 1, but which would be readily apparent to a person of ordinary skill in the art. For example, the system may include additional databases for storing user configurations, mapping rules, and access policies, as well as interfaces for interacting with third-party systems, such as ERP or WMS platforms. Other databases and systems may be added or removed as needed without departing from the scope of the invention.

FIG. 2 illustrates an example computing environment including a print data interception and processing system in accordance with an exemplary embodiment. In this example, print data interception and processing system 110 includes user device(s) interface 202, label output device(s) 204, enterprise management and data integration system interface 206, label data interception module 208, RFID encoding engine 210, label formatting engine 212, mapping module 214, RFID tag serialization database 216, label layout database 218, configuration and policy database 220, standards database 222, and model storage & training module 224.

User device(s) interface 202 is operable to manage the communication and data flow between user device(s) and print data interception and processing system 110. More specifically, user device(s) interface 202 facilitates the exchange of commands, requests, and display data between user device(s) and other components of print data interception and processing system 110, allowing users, such as administrators or end-users, to interact with the system.

For example, in an embodiment, user device(s) interface 202 is operable to transmit notifications regarding intercepted print jobs, their classification, or policy enforcement outcomes to user device(s). These notifications may include details such as job status, policy violations, or routing decisions. Additionally, user device(s) interface 202 may receive commands from user device(s), such as approving or rejecting print jobs, modifying print job attributes, or requesting specific audit logs.

In various embodiments, user device(s) interface 202 supports interactions across a variety of device types, including desktop computers, tablets, smartphones, or other networked devices. The interface is designed to accommodate different communication protocols, such as HTTP, WebSocket, or Bluetooth, enabling seamless integration across diverse environments. For instance, an administrator may use a smartphone to remotely review and approve a print job flagged by, e.g., a print policy enforcement component or other appropriate component or service.

In certain embodiments, user device(s) interface 202 is operable to handle input from user device(s) in various formats, such as manual inputs, voice commands, or gesture-based interactions. For example, an administrator may issue a voice command to retrieve detailed print job logs or use a touchscreen gesture to approve a pending print job. User device(s) interface 202 ensures that these inputs are processed correctly and transmitted to the appropriate components within print data interception and processing system 110.

User device(s) interface 202 may also apply encryption protocols, such as TLS/SSL, to secure the data transmitted between user device(s) and the system. This ensures the confidentiality and integrity of sensitive information, such as classified print job data or audit logs, during transmission. Additionally, user device(s) interface 202 may optimize data transmission by applying compression algorithms, enabling efficient transfer of large datasets without compromising the quality or accuracy of the information.

Label output device(s) interface 204 is operable to manage the creation and output of labels based on data processed by print data interception and processing system 110. More specifically, label output device(s) interface 204 receives processed data, such as parsed print instructions or formatted label data, and converts this data into a tangible output, such as a printed label, an electronic display, or other label representations.

For example, in certain embodiments, label output device(s) interface 204 may interact with printers, e-ink displays, or other output mediums to produce labels that include barcodes, text, graphics, or encoded data necessary for various applications, such as shipping, inventory, or manufacturing tracking. The component is designed to handle multiple label formats and may dynamically adjust the label design based on predefined templates or real-time data inputs.

In various embodiments, label output device(s) interface 204 supports integration with external devices through standard communication protocols, such as USB, Ethernet, or wireless technologies like Wi-Fi or Bluetooth. For instance, the component may be configured to wirelessly connect with handheld label printers, enabling portability and flexibility in label generation. Alternatively, label output device(s) interface 204 may connect to industrial labelers for high-volume printing tasks.

Label output device(s) interface 204 is operable to ensure the quality and integrity of the generated labels. This may involve performing error-checking routines, such as verifying barcode readability or ensuring that label content matches the processed data. Additionally, the component may store a log of output labels for audit and traceability purposes.

In some embodiments, label output device(s) interface 204 includes a user interface that allows operators to preview and customize labels before output. This interface may provide options to adjust label parameters, such as size, orientation, or content layout, ensuring that the output meets specific user requirements or operational standards. Furthermore, the component may provide feedback to print data interception and processing system 110, such as status updates or error reports, to facilitate system-wide monitoring and diagnostics.

Enterprise management and data integration system interface 206 is operable to manage communication and data exchange between print data interception and processing system 110 and external enterprise management systems. More specifically, this component ensures seamless integration of processed output data fields, including label data, into larger enterprise workflows, such as inventory management, logistics, or supply chain systems.

For example, in certain embodiments, enterprise management and data integration system interface 206 may facilitate real-time updates to an enterprise resource planning (ERP) system by transmitting label information, such as product identifiers, shipment details, or inventory counts. In an embodiment, this ensures that enterprise systems are synchronized with label generation and associated data processing activities.

In various embodiments, enterprise management and data integration system interface 206 supports multiple communication protocols and data formats to ensure compatibility with diverse enterprise systems. These protocols may include REST APIs, SOAP, or proprietary interfaces provided by enterprise management software. For example, the component may translate output data fields, including label data, into a format compatible with a specific ERP system, ensuring accurate and efficient data ingestion.

In certain embodiments, enterprise management and data integration system interface 206 is operable to retrieve data from enterprise systems to inform label generation. For instance, the interface may pull product descriptions, lot numbers, or shipping instructions from an ERP or warehouse management system (WMS) and pass this information to print data interception and processing system 110 for processing and label creation.

In some embodiments, enterprise management and data integration system interface 206 includes a monitoring feature that tracks data exchange activities, such as successful transmissions, errors, and system status updates. This tracking ensures transparency and facilitates troubleshooting in the event of integration issues. Additionally, the component may provide audit trails for compliance and traceability purposes.

Label data interception module 208 is operable to intercept, analyze, and process formatted output data, such as print data streams directed toward label-generating devices. More specifically, label data interception module 208 identifies, captures, and reformats data embedded in print instructions to ensure compatibility with label output device(s) interface 204 or enterprise workflows.

For example, in certain embodiments, label data interception module 208 intercepts raw formatted output data streams from a host system, such as a warehouse management system (WMS) or enterprise resource planning (ERP) software. In an embodiment, label data interception module 208 parses these streams to extract relevant output data fields, including label data, such as product identifiers, barcodes, or text fields. This parsed data can then be reformatted according to predefined templates or operational requirements and passed to print data interception and processing system 110 for further processing.

In various embodiments, label data interception module 208 supports diverse data sources and formats, such as PCL (Printer Command Language), ZPL (Zebra Programming Language), or other printer-specific command languages. The module is designed to adapt to varying input streams, ensuring compatibility with a wide range of enterprise printing environments.

In certain embodiments, label data interception module 208 is operable to perform data enrichment by augmenting the intercepted data with additional contextual information retrieved from enterprise management systems via enterprise management and data integration system interface 206. For instance, the module may enhance intercepted formatted output data by appending shipment details, lot numbers, or compliance-related information to meet labeling standards.

Additionally, label data interception module 208 may include error-checking and validation routines to ensure the integrity and accuracy of intercepted data. For example, the module can detect incomplete or malformed data streams and trigger corrective actions, such as requesting retransmission or alerting system operators.

In some embodiments, label data interception module 208 supports real-time monitoring and logging of intercepted data streams. This functionality enables operators to review data interception activities, ensuring traceability and compliance with enterprise policies. Furthermore, the module may provide feedback to print data interception and processing system 110, such as error notifications or data metrics, to support overall system performance monitoring and optimization.

RFID encoding engine 210 is operable to encode and program RFID tags associated with labels processed by print data interception and processing system 110. More specifically, RFID encoding engine 210 ensures that RFID tags are programmed with the appropriate data, such as product identifiers, shipment details, or inventory tracking information, to enable seamless integration into RFID-based systems.

For example, in certain embodiments, RFID encoding engine 210 retrieves data from label output device(s) interface 204 or enterprise management and data integration system interface 206 and encodes this data onto RFID tags. The encoded data may include serialized identifiers, batch numbers, expiration dates, or shipping instructions, depending on the label's requirements.

In various embodiments, RFID encoding engine 210 supports multiple RFID standards and encoding protocols, such as EPCglobal Class 1 Gen 2 or ISO/IEC 18000-63. This enables compatibility with a wide range of RFID readers and enterprise systems. For instance, the engine may encode RFID tags to align with a specific supply chain standard, ensuring interoperability across different stages of the logistics process.

In certain embodiments, RFID encoding engine 210 is operable to verify the accuracy and integrity of encoded RFID tags. This verification may involve reading back the encoded data to ensure it matches the source data and flagging any discrepancies for correction. Additionally, the component may validate the RFID tags against enterprise rules or regulatory requirements before completing the encoding process.

In some embodiments, RFID encoding engine 210 includes features for optimizing encoding efficiency. For example, the engine may use batch encoding techniques to program multiple RFID tags simultaneously or apply error correction algorithms to enhance the reliability of encoded data. Additionally, the engine may monitor encoding performance metrics, such as success rates or error rates, to ensure consistent operation.

In certain configurations, RFID encoding engine 210 is integrated with label data interception module 208 to provide synchronized label printing and RFID encoding. For instance, the system may simultaneously print a label and encode its associated RFID tag, ensuring that both components are perfectly aligned for subsequent use.

Label formatting engine 212 is operable to process and format output data fields, including label data, intercepted and processed by print data interception and processing system 110. More specifically, label formatting engine 212 ensures that label data complies with predefined templates, regulatory requirements, and operational standards for label creation.

For example, in certain embodiments, label formatting engine 212 retrieves parsed and processed label data from label data interception module 208 and applies formatting rules to generate label designs. These rules may include layout specifications, font styles, barcode placements, and graphical elements to create labels suitable for applications such as shipping, inventory management, or product tracking.

In various embodiments, label formatting engine 212 supports dynamic formatting based on context or input data. For instance, the component may adapt the label design based on the destination country, regulatory requirements, or enterprise-specific branding guidelines. If a shipping label requires additional compliance information, such as a hazardous material warning, label formatting engine 212 may append the necessary elements to the label layout.

In certain embodiments, label formatting engine 212 is operable to validate the generated label designs against predefined standards or templates. This may involve ensuring that barcodes conform to specific formats, such as Code 128 or QR codes, or that text fields align with spatial constraints in the label layout. Any discrepancies identified during validation may be flagged for correction or reformatted automatically.

Additionally, label formatting engine 212 integrates with label output device(s) interface 204 to ensure compatibility between the formatted label designs and output devices. For example, the component may convert label data into a format supported by a specific printer or display, such as ZPL (Zebra Programming Language), PCL (Printer Command Language), or other device-specific formats.

In some embodiments, label formatting engine 212 provides a user interface or configuration tool for administrators to define or modify label templates. This interface may allow users to specify layout elements, customize branding features, or configure formatting rules to meet operational needs. For instance, an administrator may create a custom label template with specific font styles and barcode positions for use in a regional distribution center.

In certain configurations, label formatting engine 212 supports integration with enterprise management and data integration system interface 206 to retrieve additional data for label generation. For example, the engine may pull product descriptions, lot numbers, or compliance-related details from an enterprise resource planning (ERP) system to enhance label designs.

Mapping module 214 is operable to associate processed output data fields, including label data, with relevant contextual information, ensuring that label designs are appropriately linked to enterprise data sources and operational workflows. More specifically, mapping module 214 aligns label data with corresponding metadata, database entries, and external system requirements to provide a flow of information within print data interception and processing system 110.

For example, in certain embodiments, mapping module 214 retrieves label data from label formatting engine 212 and associates it with enterprise data, such as product SKUs, batch numbers, or shipment details, stored in enterprise management systems via enterprise management and data integration system interface 206. This ensures that labels include information for downstream processes, such as inventory tracking or compliance documentation.

In various embodiments, mapping module 214 supports the mapping of label data to multiple data sources, such as RFID tag serialization database 216, label layout database 218, and standards database 222. For instance, the module may retrieve serialization information from RFID tag serialization database 216 to embed unique identifiers into the label data, ensuring traceability throughout the supply chain.

In certain embodiments, mapping module 214 is operable to map label data dynamically based on real-time input or operational context. For example, during high-volume shipping operations, the module may prioritize mapping label data to the most recently updated shipment records, ensuring accuracy and timeliness. Alternatively, the module may adapt its mapping logic to comply with region-specific regulatory requirements retrieved from standards database 222.

Additionally, mapping module 214 performs validation routines to ensure the accuracy and consistency of mapped data. This may involve cross-referencing label data with enterprise records to identify discrepancies or duplications and flagging them for resolution. For example, if a product's lot number is missing or mismatched, the module may alert system operators or request updated data from enterprise systems.

In some embodiments, mapping module 214 includes error-handling mechanisms to ensure reliable operation. For instance, if an enterprise system fails to respond or provides incomplete data, the module may apply fallback strategies, such as using cached data or default values, to maintain label processing continuity.

Mapping module 214 is further operable to provide traceability by logging data mapping activities. These logs may include timestamps, source data references, and mapping outcomes, enabling administrators to review and audit the mapping process for compliance or troubleshooting purposes.

In certain configurations, mapping module 214 integrates with configuration and policy database 220 to apply mapping policies defined by administrators. For example, the module may enforce rules such as excluding non-essential data fields or prioritizing specific data sources for certain label types, ensuring adherence to operational policies.

Model storage and training module 224 is operable to manage machine learning models used within print data interception and processing system 110. More specifically, model storage and training module 224 is responsible for storing trained models, facilitating the training of new models, and enabling the updating and refinement of existing models to optimize system functionality.

For example, in certain embodiments, model storage and training module 224 stores machine learning models used by label data interception module 208 and label formatting engine 212 to identify, classify, and process label data. These models may include algorithms for text recognition, image classification, or data optimization, ensuring that the system can efficiently parse and process a wide variety of label formats and content types.

In various embodiments, model storage and training module 224 supports the training and retraining of models using historical data stored within print data interception and processing system 110. For instance, the module may use label layout patterns, print job characteristics, and intercepted data streams as training datasets to improve the accuracy and performance of machine learning models. This training process may occur on a scheduled basis or be triggered by system events, such as the introduction of new label formats or updated compliance standards.

In certain embodiments, model storage and training module 224 is operable to update stored models dynamically based on feedback from other components within the system. For example, if label output device(s) interface 204 detects errors in printed labels, such as barcode misalignment or missing data, the module may use this feedback to refine the associated machine learning models. This iterative process ensures continuous improvement in model performance and system reliability.

Additionally, model storage and training module 224 supports multiple model formats and frameworks, such as TensorFlow, PyTorch, or scikit-learn, enabling compatibility with a wide range of machine learning tools and techniques. This flexibility allows the system to leverage state-of-the-art technologies for label data processing and optimization.

In some embodiments, model storage and training module 224 includes tools for model evaluation and validation. These tools may assess the performance of machine learning models using metrics such as accuracy, precision, recall, and F1 score, ensuring that only high-performing models are deployed within the system. For instance, the module may conduct cross-validation or A/B testing to compare the effectiveness of different models and select the best-performing one for production use.

Model storage and training module 224 is further operable to manage version control for machine learning models. This includes maintaining a history of model versions, tracking changes made during updates or retraining, and providing rollback capabilities to revert to previous versions if needed. For example, if a newly trained model introduces unexpected errors or performance degradation, the module can quickly restore a stable version to minimize system disruption.

In certain configurations, model storage and training module 224 integrates with configuration and policy database 220 to ensure compliance with operational guidelines and data governance policies. For example, the module may enforce rules regarding the use of sensitive data during model training or ensure that models adhere to regulatory requirements for label content and format.

In various embodiments, model storage and training module 224 supports distributed training and deployment. For instance, the module may distribute training tasks across multiple servers or devices to accelerate the process and handle large datasets. Similarly, it may deploy trained models to edge devices, such as local label printers or scanners, to enable on-site processing and reduce latency.

Model storage and training module 224 is also operable to log training and model management activities for traceability and auditing purposes. These logs may include details such as training datasets, model parameters, evaluation results, and deployment history, providing transparency and accountability in model lifecycle management.

Print data interception and processing system 110 includes RFID tag serialization database 216, label layout database 218, configuration and policy database 220, and standards database 222. These databases are operable to store, manage, and provide access to various types of data required for label generation, RFID encoding, policy enforcement, and compliance verification. In certain embodiments, additional databases may be present, or some of these databases may be consolidated into a single database or distributed across multiple storage systems.

RFID tag serialization database 216 is operable to store unique identifiers and serialization data for RFID-encoded labels. More specifically, this database maintains records of RFID tag assignments, ensuring that each tag receives a distinct identifier that aligns with enterprise tracking and inventory systems. For example, in certain embodiments, RFID encoding engine 210 retrieves serialization data from RFID tag serialization database 216 to encode RFID tags with globally unique identifiers, such as Electronic Product Codes (EPCs). These identifiers may correspond to specific products, shipment batches, or asset tracking requirements. RFID tag serialization database 216 interacts with multiple components, including, e.g.; RFID encoding engine 210, which retrieves and updates serialization data; mapping module 214, which ensures serialized identifiers are correctly associated with corresponding label data; and enterprise management and data integration system interface 206, which facilitates synchronization with external enterprise databases. In various embodiments, RFID tag serialization database 216 may be combined with other databases, such as label layout database 218, to create a unified storage system for label metadata and tracking information.

Label layout database 218 is operable to store predefined and dynamically generated label formats used by print data interception and processing system 110. More specifically, this database contains templates, design specifications, and structural definitions that dictate how label data is formatted and presented. For example, in certain embodiments, label formatting engine 212 retrieves label templates from label layout database 218 to generate labels that conform to industry standards and enterprise requirements. These templates may define label size, barcode placement, text formatting, and other visual elements. Label layout database 218 interacts with multiple components, including, e.g., label formatting engine 212, which uses stored templates to generate formatted labels; mapping module 214, which associates retrieved label formats with relevant product or shipment data; and label output device(s) interface 204, which ensures that formatted labels are printed or displayed correctly on output devices. In various embodiments, label layout database 218 may be integrated with configuration and policy database 220 to enforce layout policies, such as regulatory compliance requirements for specific industries.

Configuration and policy database 220 is operable to store system-wide configurations, operational policies, and rule-based enforcement criteria used by print data interception and processing system 110. More specifically, this database contains parameters that dictate how intercepted formatted output data is processed, modified, and distributed. For example, in certain embodiments, print data interception and processing system 110 references configuration and policy database 220 to determine print job handling rules, such as whether a specific label should be formatted in compliance with a given standard, assigned an RFID tag, or routed to a particular output device. Configuration and policy database 220 interacts with multiple components, including, e.g., label data interception module 208, which applies policy-based modifications to intercepted label data; enterprise management and data integration system interface 206, which ensures that policy enforcement aligns with external enterprise rules; and mapping module 214, which retrieves mapping policies to structure data appropriately. In various embodiments, configuration and policy database 220 may be merged with standards database 222 to provide a unified repository for compliance-related rules and system policies.

Standards database 222 is operable to store industry regulations, compliance requirements, and global labeling standards that influence label formatting and data processing. More specifically, standards database 222 contains references to national and international regulatory frameworks, ensuring that labels meet legal and operational requirements. For example, in certain embodiments, standards database 222 provides data to label formatting engine 212 to ensure that generated labels comply with GS1 standards, ISO/IEC RFID encoding specifications, or other industry-mandated guidelines. Standards database 222 interacts with multiple components, including, e.g., mapping module 214, which ensures that label data conforms to applicable standards; configuration and policy database 220, which may apply compliance-based rules to label generation; and enterprise management and data integration system interface 206, which synchronizes external compliance updates with system policies. In various embodiments, standards database 222 may be combined with configuration and policy database 220, allowing print data interception and processing system 110 to enforce compliance and system policies from a centralized location.

In certain embodiments, the databases described herein may be combined, divided, or otherwise configured based on system requirements, performance considerations, or enterprise needs. For example: RFID tag serialization database 216 and label layout database 218 may be combined into a single repository that manages both serialization and label formatting data. Configuration and policy database 220 and standards database 222 may be merged to provide a unified compliance and policy enforcement framework. Additional databases may be included to store audit logs, historical output data fields, including label data, or user-defined configurations.

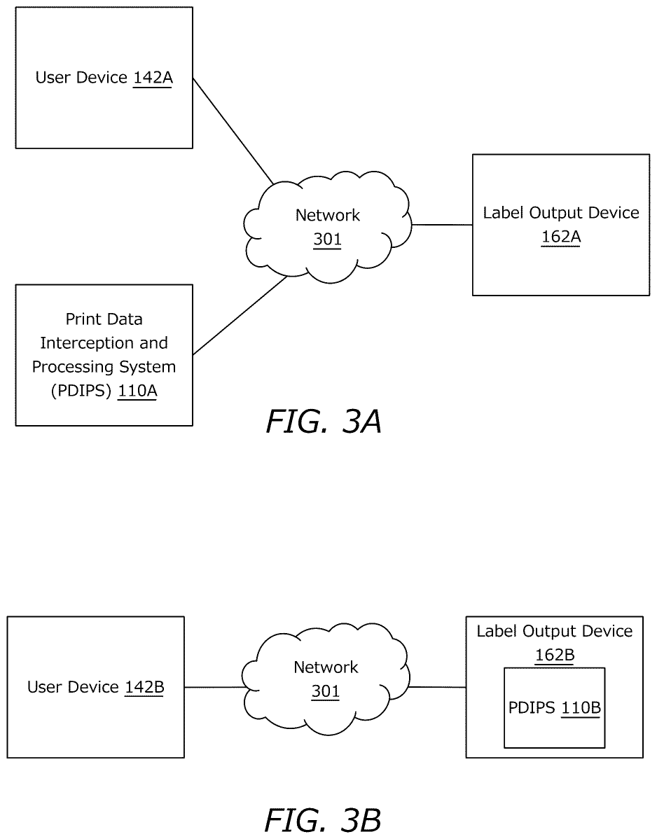

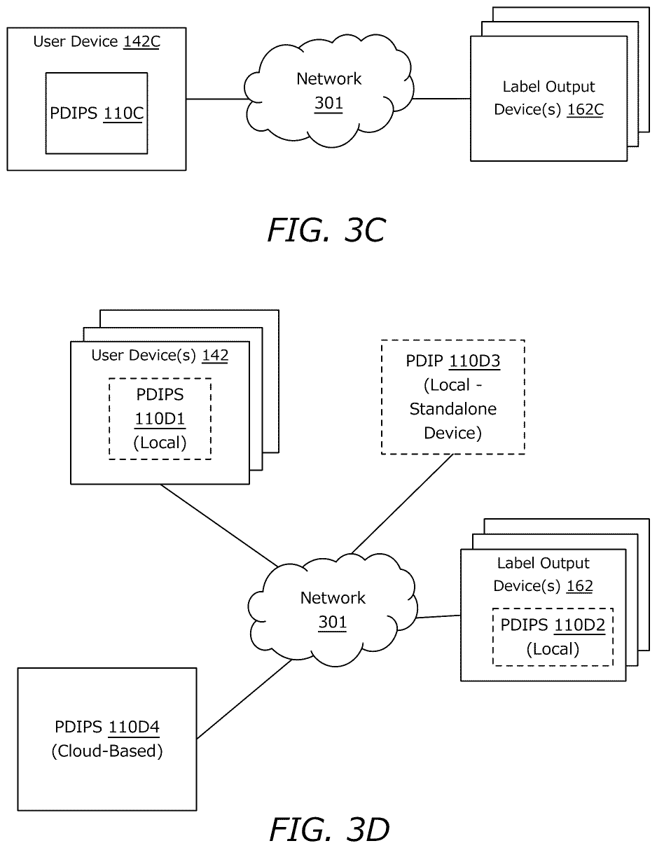

FIG. 3A, FIG. 3B, FIG. 3C, and FIG. 3D illustrate various configurations and implementations of the print data interception and processing system (PDIPS) 110 within an example computing environment. FIG. 3A, FIG. 3B, FIG. 3C, and FIG. 3D demonstrate multiple system architectures, including local, networked, and cloud-based deployments, showcasing interactions among user device(s) 142, label output device(s) 162, and PDIPS 110. In particular, the configurations highlight scenarios such as centralized processing, distributed system setups, and hybrid environments where PDIPS components may operate independently or collaboratively. The connections among the components, represented by network 301, may employ wired or wireless communication protocols, enabling flexibility in system deployment. It is noted that additional configurations, fewer devices, or alternative architectures may be utilized within the scope of the invention.

FIG. 3A illustrates an example standalone deployment of print data interception and processing system (PDIPS) 110A within a computing environment. In this configuration, PDIPS 110A operates as a standalone hardware device or virtual machine (VM) directly connected to user device(s) 142A and label output device(s) 162A via network 301. This localized deployment enables self-contained processing of a data model and label output without relying on external enterprise systems.

User device(s) 142A in FIG. 3A may include desktop computers, tablets, or other input devices that submit a data model comprising output data fields to PDIPS 110A. The data model may include fields such as product identifiers, barcodes, or other label-specific data relevant for labeling workflows. PDIPS 110A is operable to process this data model locally, identifying relevant output data fields, applying mapping rules, and encoding RFID tags where required. Label output device(s) 162A, such as industrial label printers or handheld labelers, receive the processed and formatted output data fields from PDIPS 110A for direct output.

Network 301 facilitates communication between these components and includes wired protocols such as USB or Ethernet and wireless protocols such as Wi-Fi or Bluetooth. As described in FIG. 1, network 301 may also incorporate additional communication technologies to support robust and reliable data exchange.

In various embodiments, PDIPS 110A incorporates components such as label data interception module 208, label formatting engine 212, and RFID encoding engine 210 to manage the interception, processing, and output of data models. For example, PDIPS 110A may intercept a print request containing raw label data, parse the associated data model to identify output data fields, reformat these fields into a specified label layout, encode any necessary RFID tags, and transmit the final output to label output device(s) 162A for immediate printing.

In an embodiment, the standalone deployment of PDIPS 110A, as illustrated in FIG. 3A, may be utilized in environments requiring localized control, such as on-site manufacturing facilities or warehouse management systems. By keeping data model processing and label output confined to a self-contained system, this configuration ensures efficiency and reduces dependence on external systems. Network 301 provides connectivity while allowing PDIPS 110A to function independently in operational scenarios.

Alternative embodiments may include additional user devices, label output devices, or even a supplementary connection to enterprise systems for enhanced functionality. For example, PDIPS 110A may optionally connect to an enterprise resource planning (ERP) system through network 301 to retrieve compliance data or operational metrics while maintaining its standalone capabilities.

FIG. 3B illustrates an example embedded deployment of print data interception and processing system (PDIPS) 110B within a distributed computing environment. In this configuration, PDIPS 110B operates as firmware embedded within label output device(s) 162B, enabling seamless integration between user device(s) 142B, label output device(s) 162B, and network 301. This setup supports scenarios where the label generation and processing capabilities are directly incorporated into the label output device, eliminating the need for a standalone or external PDIPS.

User device(s) 142B in FIG. 3B may represent desktop computers, tablets, or mobile devices used to submit print job data or commands to label output device(s) 162B. Label output device(s) 162B, embedded with PDIPS 110B, processes the print job data locally. Network 301 facilitates communication between user device(s) 142B and label output device(s) 162B, utilizing communication protocols such as USB, Ethernet, Wi-Fi, or Bluetooth. As described in FIG. 1, network 301 includes various connectivity technologies that enable reliable and efficient data exchange between system components.

PDIPS 110B, embedded within label output device(s) 162B, integrates components, such as label data interception module 208, label formatting engine 212, and RFID encoding engine 210. These components allow label output device(s) 162B to independently handle tasks such as intercepting raw formatted output data, such as print data, reformatting label layouts, and encoding RFID tags without requiring external processing. For instance, user device(s) 142B may send a raw print job to label output device(s) 162B, where PDIPS 110B processes the data, generates the label, and outputs it directly.

In an embodiment, the embedded deployment of PDIPS 110B, as depicted in FIG. 3B, provides a solution for environments where space, power, or external dependencies are constraints. By incorporating PDIPS functionality directly into label output device(s) 162B, this configuration reduces latency, simplifies system architecture, and enhances reliability. Network 301 ensures that user device(s) 142B can effectively communicate with the embedded system for label creation, job monitoring, or error reporting.

In various embodiments, label output device(s) 162B with embedded PDIPS 110B may operate as part of a broader networked environment, optionally interfacing with enterprise management system(s) via network 301. For example, label output device(s) 162B may pull additional metadata, such as shipment details or product descriptions, from an enterprise resource planning (ERP) system to augment label content before printing. This flexibility ensures that embedded deployments can adapt to different operational requirements and enterprise workflows.

Alternative embodiments may include additional connectivity features or modular designs, enabling embedded systems like PDIPS 110B to support additional devices, storage modules, or remote management capabilities. For instance, the embedded system may include firmware updates via network 301, ensuring that the processing and label output capabilities remain current and compliant with evolving operational standards.

FIG. 3C illustrates an example software deployment of print data interception and processing system (PDIPS) 110C installed on a computing device within a distributed computing environment. In this configuration, PDIPS 110C operates as software installed on a general-purpose computing device, such as a local server, desktop, or dedicated processing unit. The computing device is configured to connect with user device(s) 142C and label output device(s) 162C through wired or wireless communication protocols via network 301. This deployment supports the processing and management of data models and print job data, enabling flexible integration with existing IT infrastructures.

User device(s) 142C in FIG. 3C may represent devices such as desktop computers, tablets, or mobile devices that submit data models or print job data to PDIPS 110C. The data model comprises output data fields configured for labeling workflows, which PDIPS 110C processes and routes to label output device(s) 162C, such as network-connected or standalone label printers, for final output. Network 301 facilitates communication among these components, supporting protocols such as Ethernet, Wi-Fi, USB, or REST APIs. As described in FIG. 1, network 301 includes diverse communication technologies that enable reliable and efficient data exchange.

PDIPS 110C in FIG. 3C incorporates components, such as label data interception module 208, label formatting engine 212, and RFID encoding engine 210, to perform tasks including data interception, mapping output data fields to predefined label formats, formatting output data fields according to standards, and encoding RFID tags concurrently with label preparation. For instance, user device(s) 142C may submit raw print job data or a data model containing output data fields, which PDIPS 110C reformats into a compliant label layout, encodes the associated RFID tags, and sends the processed data to label output device(s) 162C for output.

In accordance with various embodiments, the software-based deployment of PDIPS 110C can leverage the computational resources of the computing device, enabling processing capabilities such as batch label generation, dynamic label layout adjustments, and integration with enterprise systems via network 301. For example, PDIPS 110C may interface with enterprise management system(s) to retrieve additional metadata, such as compliance details, product specifications, or shipping instructions, for inclusion in the label content.

In various embodiments, PDIPS 110C may support additional features, such as remote management or cloud-based connectivity, depending on the capabilities of the computing device. For example, administrators may remotely monitor print job statuses, update system configurations, or perform diagnostic checks via network 301. In an embodiment, this flexibility makes PDIPS 110C suitable for diverse operational environments, such as regional warehouses, retail centers, or manufacturing facilities.

FIG. 3C illustrates a software-based deployment implemented on existing computing infrastructure without requiring specialized hardware. Alternative embodiments may include distributed deployments where PDIPS 110C components operate across multiple computing devices to handle high-volume print jobs or complex workflows. Additionally, the computing device hosting PDIPS 110C may be integrated with external systems, such as cloud-based storage or analytics platforms, to further enhance its functionality and efficiency.

FIG. 3D illustrates a cloud-based deployment of print data interception and processing system (PDIPS) 110D within a distributed computing environment. In this configuration, PDIPS 110D includes multiple components that operate collaboratively across both cloud-based and local instances. The configuration integrates user device(s) 142, label output device(s) 162, and network 301 to facilitate connectivity and data exchange.

As shown, PDIPS 110D is represented by a cloud-based instance 110D4, which communicates with local PDIPS instances, including standalone devices 110D1 and 110D3 and firmware-integrated systems 110D2. The dashed lines connecting these components to network 301 indicate optional or dynamic connections, which may be established for specific operations, such as data synchronization or remote updates. User device(s) 142 communicates with both cloud-based and local PDIPS instances to submit print jobs, monitor system activity, or retrieve label data. Label output device(s) 162, such as network-connected printers, interact with PDIPS instances to receive formatted and encoded label data for output.

Network 301 provides the communication infrastructure for FIG. 3D, supporting wired and wireless communication protocols, such as Ethernet, Wi-Fi, cellular networks, and VPNs. The description of network 301 aligns with the network architecture outlined in FIG. 1. The optional and dynamic connections allow the system to accommodate varying operational requirements, including offline processing by local PDIPS instances or cloud-based data aggregation and analytics.

In this embodiment, PDIPS 110D operates as a cloud-based service where data models are transmitted from user device(s) 142D to the cloud-based instance 110D4 for processing. The data models include output data fields that are parsed, validated, and processed by the cloud-based instance to generate formatted data. The formatted data is then transmitted back to label output device(s) 162D over network 301 for output. For example, a user device may submit a data model containing label information, which PDIPS 110D4 processes to apply mapping rules, encode RFID tags, and format the label content. The resulting formatted data is provided to a label printer (e.g., label output device 162D) for final output.

In accordance with various embodiments, the cloud-based deployment enables centralized management and scalability, allowing PDIPS 110D4 to handle large volumes of data models and complex workflows. This configuration supports use cases such as global supply chain management, regional warehouse operations, or multi-site enterprise systems. The cloud-based architecture facilitates seamless integration with enterprise systems and other external platforms for retrieving compliance data, serialization information, or operational metrics to enhance functionality.

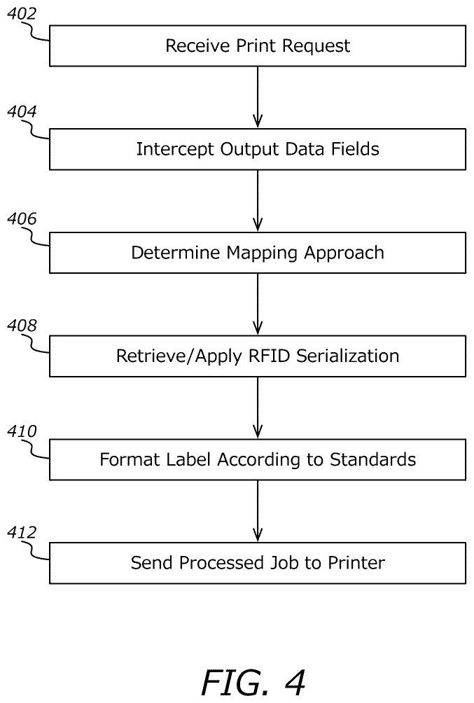

FIG. 4 illustrates an exemplary process for receiving print requests, intercepting label data, determining mapping approaches, applying RFID serialization, formatting label data, and outputting processed labels using print data interception and processing system (PDIPS) 110. The steps in this flowchart represent operations performed by one or more components of PDIPS 110, which may correspond to FIG. 1, FIG. 2, or other system configurations. The process may include additional steps, fewer steps, or steps executed in a different order without departing from the scope of the invention, as would be apparent to one of ordinary skill in the art.

At step 402, a print request is received. The print request can be received at PDIPS 110 from user device(s) 142 via network 301. The print request may include a data model comprising a plurality of output data fields. These output data fields are configured to store or represent specific parameters, values, or attributes relevant to the labeling workflows. For example, the output data fields may include raw label data, such as product identifiers, barcodes, text instructions, or print job instructions submitted by a user or an enterprise management system.

More specifically, the data model may be transmitted from the user device via a wired or wireless communication link. Upon receipt, PDIPS 110 is operable to parse the data model to identify the output data fields and their respective data types, constraints, or relationships. For instance, the system may validate the data model to ensure compliance with predefined rules or schemas, which may include checking for required fields, data formats, or alignment with labeling standards.

For example, in one embodiment, a user device 142 may transmit a print request containing a data model with output data fields, such as Field_A for a unique identifier, Field_B for a product description, and Field_C for a barcode. PDIPS 110 processes the data model, ensuring that the output data fields are correctly mapped, formatted, and integrated into subsequent labeling workflows. Additional output data fields may be appended to the data model dynamically, depending on operational needs or user-defined parameters.

At step 404, the label data is intercepted. For example, in an embodiment, the label data interception module 208 is operable to receive and analyze print streams associated with the print request. For example, the intercepted data may include raw print instructions containing product identifiers, barcodes, or shipping information. The module parses these streams to extract relevant label fields and converts the intercepted data into a format compatible with subsequent processing steps. This ensures the label data is available and structured for further processing by other components of PDIPS 110, such as mapping module 214 or RFID encoding engine 210.

At step 406, the system determines the mapping approach. In an embodiment, this step involves deciding whether to apply AI-driven mapping techniques or prompt manual mapping, based on system configurations or the complexity of the print job. Mapping module 214 is operable to facilitate this operation by referencing predefined mapping rules or initiating field association processes. For example, if a barcode field is identified but no mapping rules exist, the system may apply an AI-based detection technique to associate the field with a corresponding data type or prompt the user for manual input.

Additionally, the system analyzes the data model obtained from the user device to determine the relevancy of output data fields for labeling workflows. This analysis is performed by applying trained machine learning models, which evaluate the contextual relationship between output data fields and predefined labeling categories, such as barcodes, product identifiers, and graphical logos. The relevancy determination assigns scores to output data fields based on their importance for the labeling workflow. For example, fields marked as required by regulatory standards may receive higher relevancy scores than optional fields.

In certain embodiments, the system is operable to dynamically generate mapping rules by analyzing historical data models and label workflows using machine learning algorithms. The machine learning algorithms are trained on datasets comprising prior labeling workflows, template structures, and associated field mappings. For instance, the system may analyze historical label designs, such as templates for shipping labels or product tags, to derive new rules for field association. These dynamically generated mapping rules are stored in configuration and policy database 220 and retrieved for application during runtime.

The system applies the generated mapping rules to associate relevant output data fields with predefined label formats. For example, the system may identify output data fields such as Field_A for a product identifier, Field_B for a barcode, and Field_C for a shipping address in the data model. The dynamically generated mapping rules specify the alignment of these fields with corresponding label template elements, ensuring proper formatting and compliance with operational requirements.

The system further integrates relevancy scores determined in prior steps to refine the mapping process. For example, the system may prioritize fields with higher relevancy scores when associating fields with label formats, ensuring that critical data, such as regulatory-compliant barcodes, are mapped correctly. This integration ensures that classification and relevancy determination directly inform subsequent mapping and formatting processes.

Furthermore, the system validates the applied mapping rules against regulatory or enterprise-specific requirements to ensure compliance. For instance, if the label must adhere to GS1 standards, the system confirms that the barcode (Field_B) is correctly mapped and formatted to comply with the specified symbology and dimensions. The validated mapping ensures that the processed label data aligns with operational and compliance requirements.

At step 408, the system retrieves serialization data for RFID tags and encodes the tags. The serialization data can be obtained from distributed databases, such as RFID tag serialization database 216, cloud-based repositories, or local enterprise systems accessed via network 301. This ensures that the system has access to a comprehensive and scalable set of serialization data sources, accommodating diverse operational requirements. In certain embodiments, the system integrates the encoding process directly into the labeling workflows, performing encoding concurrently with label formatting and output preparation. This integration ensures coordination between RFID encoding and other label processing tasks, minimizing latency and maintaining workflow efficiency.

More specifically, during this step, the system utilizes the mapping and formatting information determined in step 406 to encode RFID tags with serialized data relevant to the specific labeling workflow. For example, serialization data may include unique product identifiers, batch numbers, regulatory compliance codes, or other data types necessary for RFID-enabled applications. This data is retrieved from distributed sources and encoded onto RFID tags in alignment with the label layout and formatting instructions determined in the previous step.

The encoding process is managed by RFID encoding engine 210, which communicates with other system components, such as label formatting engine 212 and mapping module 214, to ensure proper synchronization. In one embodiment, the system encodes RFID tags in real-time while simultaneously formatting the label content to be printed or displayed. For instance, a label containing a barcode, text, and an encoded RFID tag may be generated as a cohesive unit, ready for output without requiring separate processing steps.

Additionally, the system validates the encoded RFID tags to ensure compliance with regulatory standards, such as GS1 serialization requirements, or enterprise-specific rules. Validation involves reading the encoded data from the RFID tags and comparing it against the original serialization data retrieved during the encoding process. If discrepancies are detected during validation, the system may trigger corrective actions, such as re-encoding the RFID tag or generating an alert for manual review.

In accordance with various embodiments, by performing RFID encoding concurrently with label formatting and output preparation, the system enhances the efficiency of the labeling process, reduces the need for separate encoding hardware, and ensures that encoded data is correctly aligned with the intended labeling workflow. The ability to validate encoded tags against distributed serialization databases ensures data integrity and regulatory compliance across diverse operational scenarios.

At step 410, the system formats the output data fields according to predefined standards to generate formatted data and provides the formatted data to at least one output device. This step ensures that the processed data is prepared in a manner that aligns with regulatory, enterprise, or operational requirements.

In an embodiment, the formatting process can be performed by label formatting engine 212, which applies formatting rules determined in previous steps, such as those derived from mapping module 214. The formatting rules may include instructions for aligning text, scaling graphical elements, and arranging barcodes or other data types according to predefined templates. For example, the system may format a shipping label to include a barcode in the upper-left corner, a product description in the center, and a shipping address in the lower-right corner, as specified by enterprise policies or industry standards such as GS1.

In certain embodiments, the system retrieves layout instructions embedded within the data model obtained from the user device. These layout instructions define the structural arrangement of output data fields within the label, such as positional coordinates, font styles, and graphical dimensions. For instance, the layout instructions may specify placing Field_A (product identifier) in a bold font at the top-center of the label, aligning Field_B (barcode) in a horizontal orientation at the bottom-left corner, and rendering Field_C (shipping address) in italics below the barcode.

The system generates a label layout from the formatted data by applying the layout instructions to organize the output data fields into predefined or custom label formats. Label formatting engine 212 ensures that the generated label layout complies with applicable standards, such as GS1 or enterprise-specific guidelines, by validating the spatial arrangement, text styles, and graphical elements specified by the layout instructions.

In certain embodiments, to further align the label layout with specific standards, the system applies additional formatting rules stored in configuration and policy database 220 or label layout database 218. For example, the system may ensure that barcodes conform to specific symbologies, such as Code 128 or QR codes, and that text elements are displayed in enterprise-defined fonts and sizes. These rules ensure that the generated label layout meets operational and compliance requirements.

Additionally, the system dynamically adjusts graphical or text elements within the label layout based on predefined formatting rules. This adjustment may include resizing text to fit within designated areas, repositioning graphical elements to avoid overlaps, or changing font styles to enhance readability. For example, if a barcode exceeds the allocated space, the system may proportionally scale the barcode while preserving its scannability.

In certain embodiments, the formatted data is provided to at least one output device for output. The output device, such as a label printer, electronic display, or RFID encoder, is different from the user device from which the data model was obtained. The system communicates with the output device via network 301, using standard protocols such as USB, Ethernet, or wireless connections, to transmit the formatted data for final output.

For example, the system may transmit a formatted label containing text, a barcode, and an encoded RFID tag to a network-connected printer. The printer processes the formatted data to produce a physical label that meets enterprise or regulatory specifications. Alternatively, the system may transmit the formatted data to an electronic display for visual representation or to an RFID encoder for tag programming.

At step 412, the processed label data is sent to label output device(s) 162 for printing or electronic display. This step involves transmitting the formatted and encoded label data via network 301 using communication protocols supported by the output devices. For example, the system may send the formatted label to a network-connected printer for physical label generation or to an e-ink display for digital visualization. The transmission ensures that the output device accurately renders the processed label as intended.

The process shown in FIG. 4 illustrates functionalities of PDIPS 110, which can vary depending on deployment configurations described in FIGS. 3A through 3D. For example, PDIPS 110 may function as a standalone hardware device (FIG. 3A), a firmware-integrated system (FIG. 3B), software installed on a local or server-based computing device (FIG. 3C), or a cloud-hosted service (FIG. 3D). Each deployment configuration may involve distinct network setups, including direct connections, distributed processing, or synchronization via network 301. Network 301 may include local area networks (LAN), wide area networks (WAN), wireless networks, or the internet, facilitating seamless connectivity among system components. These configurations allow PDIPS 110 to accommodate specific operational needs, such as local processing, remote management, or hybrid workflows. Additional, fewer, or alternative steps may be implemented within the scope of the invention to address specific use cases, such as integration with enterprise systems or customizing label outputs. In certain embodiments, the operations described in FIG. 4 may also include optional data validation, error correction, audit logging, or distributed processing to ensure reliability, traceability, and scalability.

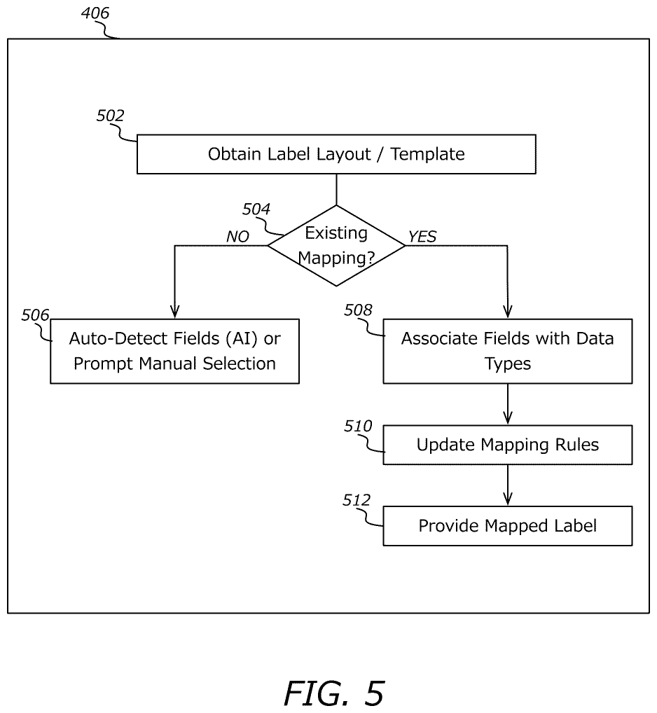

FIG. 5 illustrates an exemplary process for mapping label data fields to corresponding data types as part of step 406 in FIG. 4. In accordance with various embodiments, the process is implemented by components within print data interception and processing system (PDIPS) 110 and may involve operations performed by mapping module 214, label formatting engine 212, and other associated components. The process may include additional steps, fewer steps, or steps executed in a different order without departing from the scope of the invention, as would be apparent to one of ordinary skill in the art.

At step 502, a label layout or template is obtained. Mapping module 214 works with label formatting engine 212 to perform this operation. The system retrieves predefined templates or user-specified layouts from configuration and policy database 220 or label layout database 218. For example, predefined layouts may include configurations for shipping labels, which define fields for product identifiers, barcodes, and graphical logos, or pallet labels, which include fields for lot numbers, batch codes, and compliance markings. Alternatively, templates may be dynamically generated based on enterprise policies retrieved via enterprise management and data integration system interface 206. These templates ensure that the label structure aligns with operational requirements and regulatory standards.

At step 504, the system determines whether an existing mapping is available for the intercepted label data. In an embodiment, mapping module 214 cross-references intercepted data fields with stored mapping rules in configuration and policy database 220. For instance, if a previously defined mapping associates a “Product ID” field in the intercepted data with a specific barcode format, the system proceeds to step 510. If no existing mapping is identified, the process transitions to step 506 for further analysis.

At step 506, fields in the intercepted label data are automatically detected using AI techniques or manually selected through user interaction. Mapping module 214 leverages trained machine learning models to perform field detection. These models are trained using diverse datasets containing labeled examples of common label data structures, including numerical sequences representing product identifiers, alphanumeric strings as serial numbers, and graphical components like logos. For instance, a convolutional neural network (CNN) trained on such datasets may analyze intercepted formatted output data to classify fields as barcodes or text fields. The training data for these models may include synthetic label data, historical print jobs, and manually annotated examples to ensure robust detection across varied scenarios. In scenarios where AI-driven detection is insufficient or ambiguous, the system prompts manual input via user device(s) 142. This may involve displaying the raw data fields to the user and allowing manual assignment of data types through an interactive interface.

At step 508, the detected fields are associated with specific data types. In an embodiment, mapping module 214 matches fields with corresponding data types based on predefined rules or user input. For example, a detected field containing a numerical sequence may be associated with a “Lot Number” data type, while a string field may be associated with a “Shipping Address.” These associations can be stored in configuration and policy database 220 to facilitate subsequent label formatting and reuse in future mappings.

At step 510, the mapping rules are updated. In an embodiment, this involves adding new mappings or refining existing ones to ensure accuracy and consistency. For example, if a user manually associates a field with a data type, the system stores this association for automatic application in future label processing tasks. Mapping module 214 may also validate the updated rules against operational policies retrieved from configuration and policy database 220 to ensure compliance with enterprise or regulatory requirements.

At step 512, the mapped label is provided for further processing. Label formatting engine 212 incorporates the mapped fields into the label template or layout obtained in step 502. For instance, mapped data such as product identifiers, barcodes, and text fields are inserted into the appropriate template positions, ensuring that the label adheres to the specified format. The formatted label is then forwarded for subsequent steps, such as RFID encoding or label printing, as described in FIG. 4.

In accordance with various embodiments, depending on the deployment configuration described in FIGS. 3A through 3D, this process may be executed locally on PDIPS instances, in firmware-integrated systems, or in cloud-based environments. Additionally, the process supports distributed workflows, where mapping operations may occur on different components of PDIPS 110, enabling efficient handling of complex label processing tasks.

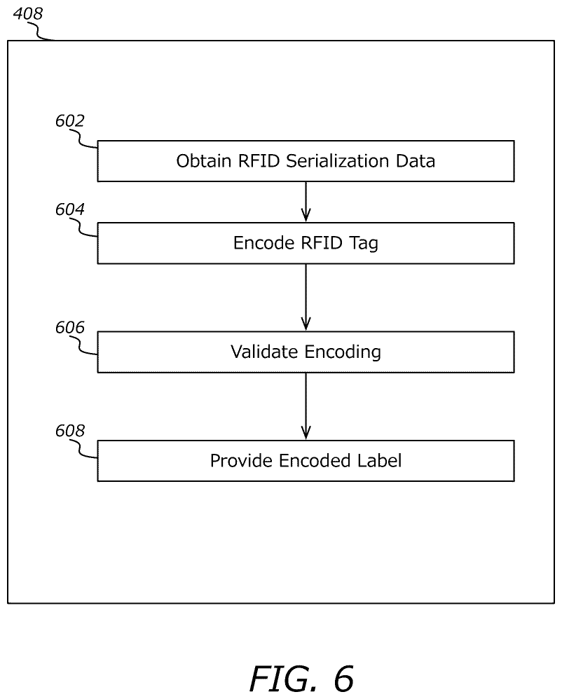

FIG. 6 illustrates an exemplary process for encoding RFID tags as part of step 408 in FIG. 4. In an embodiment, the process can be implemented by components within print data interception and processing system (PDIPS) 110, such as RFID encoding engine 210, label formatting engine 212, and other associated components. The steps may include additional, fewer, or differently ordered steps without departing from the scope of the invention, as would be apparent to one of ordinary skill in the art.

At step 602, RFID serialization data is obtained. In an embodiment, this step is executed by RFID encoding engine 210, which retrieves serialization information from configuration and policy database 220 or RFID tag serialization database 216. For example, serialization data may include globally unique identifiers (GUIDs), Electronic Product Codes (EPCs), or custom enterprise-assigned codes used to track individual items. This data may also be dynamically generated or retrieved from external enterprise management systems via enterprise management and data integration system interface 206, ensuring that the serialization aligns with operational or regulatory requirements.

At step 604, an RFID tag is encoded. RFID encoding engine 210 uses the serialization data obtained in step 602 to program RFID tags. This involves writing the serialized data onto RFID chips using encoding standards, such as EPCglobal Class 1 Gen 2 or ISO/IEC 18000-63. For example, the encoding process may involve transmitting data via high-frequency (HF) or ultra-high-frequency (UHF) RFID encoders integrated into label output device(s) interface 204. This ensures that the RFID tag includes the necessary information for item tracking, shipment validation, or inventory control.

At step 606, the encoded RFID tag is validated. RFID encoding engine 210 verifies the accuracy and integrity of the data written to the RFID tag. Validation techniques may include reading back the encoded data and comparing it against the original serialization data retrieved in step 602. For example, checksum algorithms or redundancy checks may be applied to ensure that the encoded data matches the intended content. In scenarios where validation fails, the system may trigger a re-encoding attempt or generate an error notification for operator intervention.

At step 608, the encoded label is provided. The label, which includes the RFID-encoded tag, is integrated with the corresponding printed label data formatted in earlier steps (e.g., step 406 in FIG. 4). RFID encoding engine 210 or label formatting engine 212 ensures that the encoded tag aligns with the associated printed label, combining both visual and electronic data representations. The completed label is then transmitted to label output device(s) 162 for physical output. For example, the label may be printed on a thermal transfer printer with embedded RFID encoding capabilities, resulting in a label that can be both visually inspected and electronically scanned.

FIG. 6 further illustrates the adaptability of the RFID encoding process across the configurations described in FIGS. 3A through 3D. Depending on the deployment scenario, RFID encoding engine 210 may operate on standalone PDIPS instances (e.g., 110A or 110C), within firmware-integrated systems (e.g., 110B), or as part of a cloud-based instance (e.g., 110D). The process may also be distributed, with serialization data retrieved from enterprise systems and encoding performed locally, ensuring efficient and scalable label production workflows.

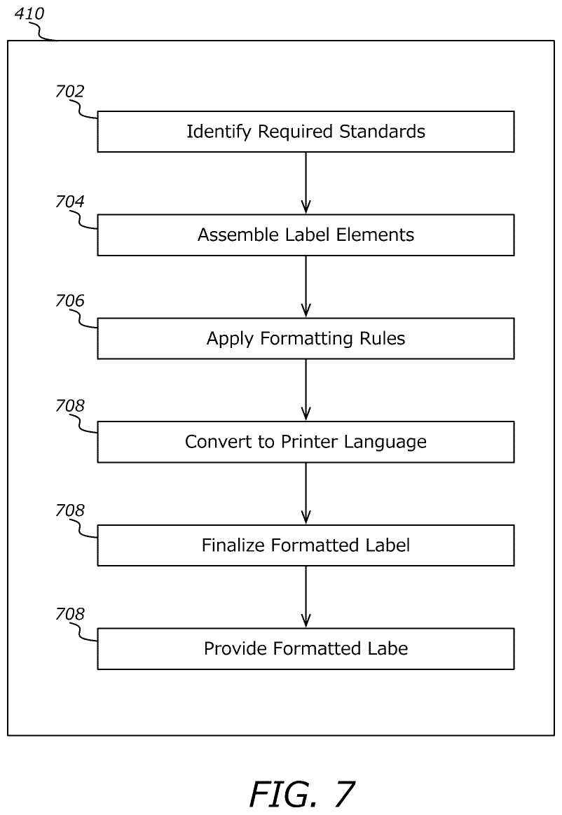

FIG. 7 illustrates an exemplary process for label formatting as part of step 410 in FIG. 4. In an embodiment, the process is executed by components of print data interception and processing system (PDIPS) 110, including label formatting engine 212, mapping module 214, and other associated components. The steps may include additional, fewer, or differently ordered steps without departing from the scope of the invention, as would be apparent to one of ordinary skill in the art.

At step 702, required standards for label formatting are identified. This step is performed by label formatting engine 212 in conjunction with configuration and policy database 220 and standards database 222. For example, the system may determine that a shipping label must comply with specific regulatory requirements, such as GS1 standards for barcoding or ISO standards for RFID encoding. Additionally, enterprise policies retrieved via enterprise management and data integration system interface 206 may specify custom formatting rules, such as the inclusion of company logos, color codes, or proprietary data structures.

At step 704, label elements are assembled. Label formatting engine 212 retrieves the necessary data fields and graphical elements from configuration and policy database 220 or label layout database 218. These elements may include barcodes, product descriptions, shipping addresses, and graphical assets such as company logos. For example, the system may use predefined label templates or dynamically generate layouts based on mapping rules defined in mapping module 214. The system ensures that all required elements are accurately integrated into the label design while adhering to the identified standards.

At step 706, formatting rules are applied. Label formatting engine 212 applies formatting rules to the assembled label elements, ensuring compliance with operational and regulatory standards. This may involve adjusting text alignment, scaling graphical elements, and positioning data fields within the label layout. For example, barcodes may be resized to meet scanner compatibility requirements, while text fields may be adjusted for readability. Additionally, formatting rules may include encoding specific metadata into the label design, such as serialization data for traceability.

At step 708, the label is converted to a printer-compatible language. Label formatting engine 212 translates the formatted label design into a printer language supported by label output device(s) 162. Examples of printer languages include Printer Command Language (PCL), Zebra Programming Language (ZPL), and PostScript. For instance, a label designed for a thermal transfer printer may be converted into ZPL commands that specify the label's dimensions, field positions, and print density. This ensures that the label design is accurately rendered by the target printer.

At step 710, the finalized formatted label is provided. The completed label is transmitted to label output device(s) 162 for printing or electronic display. Label formatting engine 212 ensures that the label is compatible with the output device's capabilities and specifications. For example, the system may optimize the label design for high-resolution printing on industrial printers or for display on e-ink devices. Additionally, the finalized label may include both visual elements and encoded data, such as RFID tags, enabling multimodal use in inventory management or shipping workflows.

FIG. 7 also reflects the adaptability of the label formatting process across the configurations described in FIGS. 3A through 3D. Depending on the deployment scenario, label formatting engine 212 may operate on standalone PDIPS instances (e.g., 110A or 110C), within firmware-integrated systems (e.g., 110B), or as part of a cloud-based instance (e.g., 110D). The process may also support distributed processing, with formatting tasks divided among local and centralized components to optimize performance and scalability.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

Any of the above-mentioned systems, units, modules, engines, controllers, interfaces, components, or the like may comprise hardware and/or software as described herein. For example, the systems described in association with print data interception and processing system (PDIPS) 110, RFID encoding engine 210, label formatting engine 212, label data interception module 208, mapping module 214, configuration and policy database 220, and subcomponents thereof may comprise computing hardware and/or software as described herein in association with the figures. Furthermore, any of the above-mentioned systems, units, modules, engines, controllers, interfaces, components, or the like may use and/or comprise an application programming interface (API) for communicating with other systems, units, modules, engines, controllers, interfaces, components, or the like for obtaining and/or providing data or information.

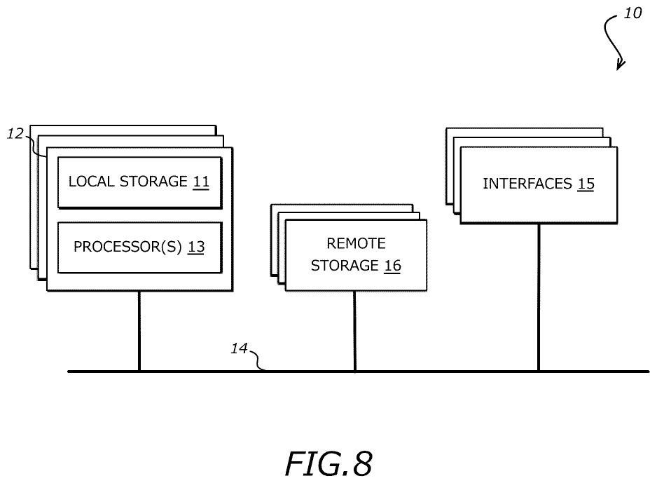

Referring now to FIG. 8, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 8 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

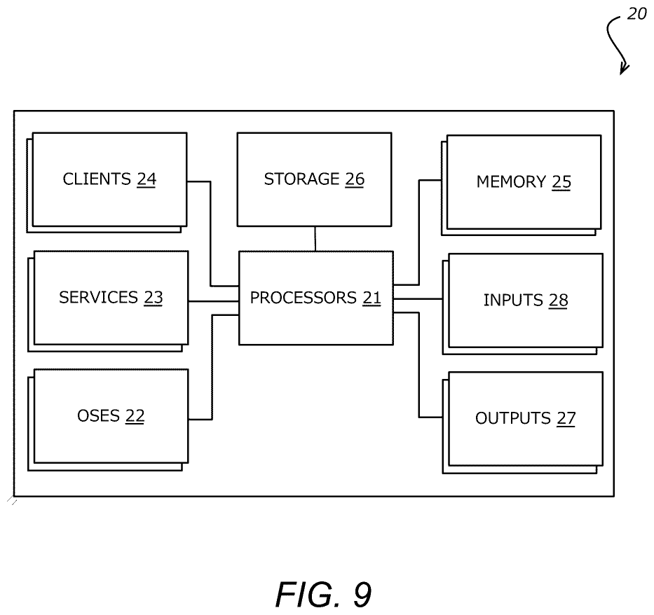

In some embodiments, systems may be implemented on a standalone computing system. Referring now to FIG. 9, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 8). Examples of storage devices 26 include flash memory, magnetic hard drive, CD-ROM, and/or the like.

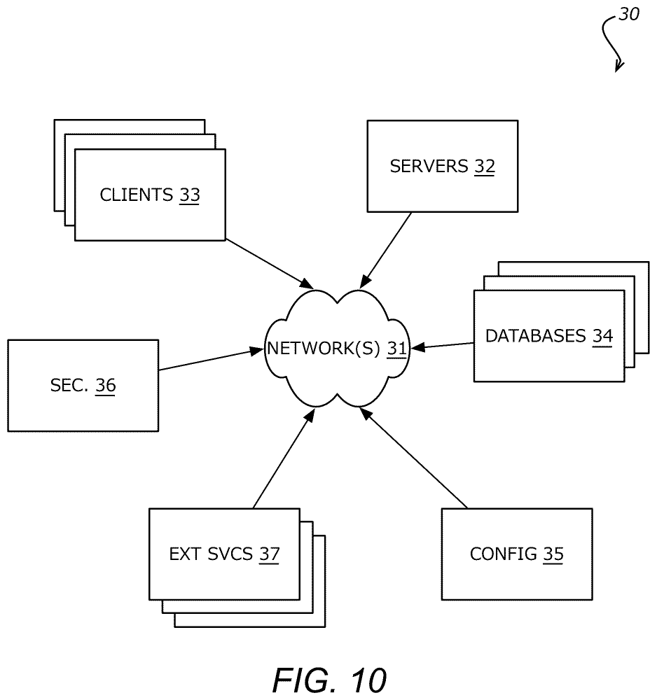

In some embodiments, systems may be implemented on a distributed computing network, such as one having any number of clients and/or servers. Referring now to FIG. 10, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 9. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

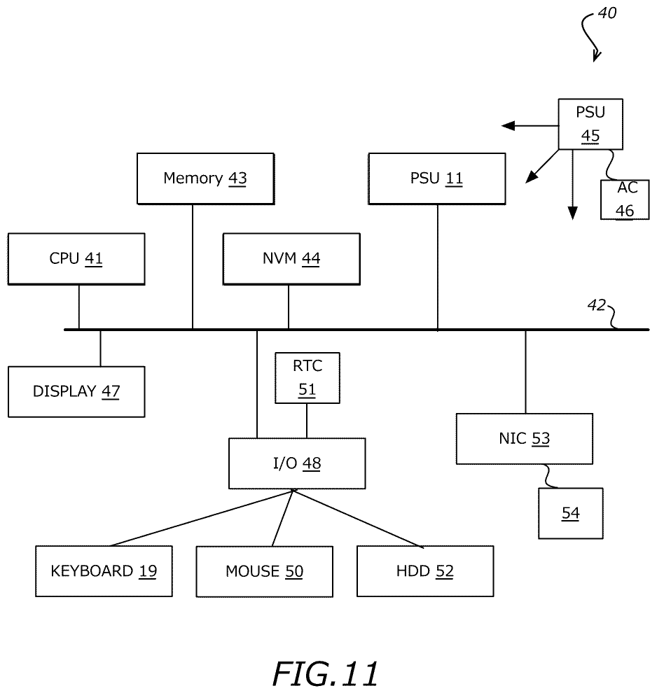

FIG. 11 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for facilitating database queries through the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A print data interception and processing system (PDIPS), comprising:
at least one computing processor; and
memory including instructions that, when executed by the at least one computing processor, enable the PDIPS to:
obtain a data model from a user device, the data model comprising output data fields;
identify output data fields relevant for labeling workflows;
apply mapping rules to associate relevant output data fields with predefined label formats;
encode RFID tags with serialization data integrated directly into the labeling workflows, wherein encoding is performed concurrently with label formatting and output preparation;
retrieve serialization data from data sources;
format the output data fields according to standards to generate formatted data; and
provide the formatted data to at least one output device for output, wherein the at least one output device is different from the user device.

2. The PDIPS of claim 1, wherein the PDIPS is configured as a standalone device operable to process the data model locally, the standalone device being connected to the user device and the at least one output device via a local network.

3. The PDIPS of claim 1, wherein the PDIPS is integrated within firmware of the at least one output device.

4. The PDIPS of claim 1, wherein the PDIPS is implemented as a software-based deployment on a computing device, the computing device being configured to connect with the user device and the at least one output device through a wired or wireless connection.

5. The PDIPS of claim 1, wherein the PDIPS is implemented as a cloud-based service, wherein data models are transmitted from the user device to the cloud-based service and formatted data is provided to the at least one output device over a network.

6. The PDIPS of claim 1, wherein the instructions, when executed by the at least one computing processor to identify output data fields relevant for labeling workflows, further enables the PDIPS to:
apply a trained machine learning model to the data model;
determine relevancy of output data fields for labeling workflows; and
classify the output data fields based on the relevancy to predefined labeling categories.

7. The PDIPS of claim 1, wherein the instructions, when executed by the at least one computing processor to apply mapping rules to associate the relevant output data fields with predefined label formats, further enables the PDIPS to:
generate mapping rules by analyzing historical data models and label workflows using machine learning algorithms; and
apply generated mapping rules to associate the relevant output data fields with corresponding label formats.

8. The PDIPS of claim 1, wherein the instructions, when executed by the at least one computing processor to encode RFID tags with serialization data, further enables the PDIPS to:
retrieve serialization data from distributed databases; and
validate encoded RFID tags against regulatory or enterprise-specific requirements.

9. The PDIPS of claim 1, wherein the instructions, when executed by the at least one computing processor to format the output data fields, further enables the PDIPS to:
retrieve layout instructions embedded within the data model; and
apply the layout instructions to generate a formatted label.

10. The PDIPS of claim 1, wherein the instructions, when executed by the at least one computing processor to format the output data fields, further enables the PDIPS to:
generate a label layout from the formatted data;
align the label layout to comply with specific standards; and
adjust graphical or text elements based on predefined formatting rules.

11. A computer-implemented method for processing data models for labeling workflows, comprising:
performing processing operations that include:
obtaining, by a processor, a data model from a user device, the data model comprising output data fields;
identifying output data fields relevant for labeling workflows;
applying mapping rules to associate relevant output data fields with predefined label formats;
encoding RFID tags with serialization data integrated directly into the labeling workflows, wherein the encoding is performed concurrently with label formatting and output preparation;
retrieving serialization data from data sources;
formatting the output data fields according to standards to generate formatted data; and
providing the formatted data to at least one output device for output, wherein the at least one output device is different from the user device.

12. The computer-implemented method of claim 11, wherein the data model is processed by a standalone device connected to the user device and the at least one output device via a local network.

13. The computer-implemented method of claim 11, wherein the processing operations are performed by a system integrated within firmware of the at least one output device.

14. The computer-implemented method of claim 11, wherein the processing operations are performed by a standalone device operable to process the data model locally.

15. The computer-implemented method of claim 11, further comprising:
using a trained machine learning model to analyze the data model;
determining relevancy of output data fields for labeling workflows; and
classifying the output data fields based on the relevancy to predefined labeling categories.

16. The computer-implemented method of claim 11, further comprising:
generating mapping rules by analyzing historical data models and label workflows using artificial intelligence algorithms; and
applying generated mapping rules to associate the relevant output data fields with predefined label formats.

17. The computer-implemented method of claim 11, further comprising:
retrieving layout instructions embedded within the data model; and
applying the layout instructions to generate a formatted label.

18. A non-transitory computer readable storage medium storing instructions that, when executed by at least one processor of a computing system, causes the computing system to:
perform processing operations comprising:
obtaining a data model from a user device, the data model comprising output data fields;
identifying output data fields relevant for labeling workflows;
applying mapping rules to associate relevant output data fields with predefined label formats;
encoding RFID tags with serialization data integrated directly into the labeling workflows, wherein the encoding is performed concurrently with label formatting and output preparation;
retrieving serialization data from data sources;
formatting the output data fields according to standards to generate formatted data; and
providing the formatted data to at least one output device for output, wherein the at least one output device is different from the user device.

19. The non-transitory computer readable storage medium of claim 18, wherein the processing operations are performed by a system integrated within firmware of the at least one output device.

20. The non-transitory computer readable storage medium of claim 18, wherein the processing operations are performed by a standalone device operable to process the data model locally.
